(19) United States
(12) Patent Application Publication
(10) Pub. No.: US 2026/0245918 A1
(43) Pub. Date: Aug. 20, 2026

(54) METAL SEPARATOR AND METHOD FOR MANUFACTURING THE SAME

(71) Applicant: Hyundai Steel Company, Incheon (KR)

(72) Inventors: Jae Ho Lee, Incheon (KR); Won Seog Yang, Incheon (KR); Hee Suk Roh, Incheon (KR); Dae Hong Ha, Incheon (KR)

(21) Appl. No.: 19/400,785

(22) Filed: Nov. 25, 2025

(30) Foreign Application Priority Data
Feb. 14, 2025 (KR) 10-2025-0019556

(51) Int. Cl. H01M 8/0208; H01M 8/0228

(52) U.S. Cl. CPC H01M 8/0208; H01M 8/0228

(57) ABSTRACT

The present disclosure relates to a metal separator and a method for manufacturing the same. According to present disclosure, a metal separator having excellent electrical conductivity and corrosion resistance, and a method for manufacturing the same may be provided.

### CROSS-REFERENCE TO RELATED APPLICATION(S)

This application claims benefit of priority to Korean Patent Application No. 10-2025-0019556 filed on Feb. 14, 2025 in the Korean Intellectual Property Office, the disclosure of which is incorporated herein by reference in its entirety.

### BACKGROUND

### 1. Field

The present disclosure relates to a metal separator and a method for manufacturing the same.

### 2. Description of Related Art

Fuel cells used in hydrogen fuel cell electric vehicles are utilized as a power source that generates electricity through an electrochemical reaction between reaction gases and a catalyst. Among the components used in fuel cells, a metal separator is a key component that performs the role of collecting and transmitting the electricity generated during the electrochemical reaction.

Stainless steel or Ti materials are primarily used for the metal separators. These stainless steel or Ti-based metal separators exhibit excellent corrosion resistance by forming a passive layer composed of Cr₂O₃ or TiO₂ with a thickness of 10 Å or more and 50 Å or less, in an oxygen-containing environment. However, in the fuel cell operating environment, F⁻ and SO₄²⁻ are generated due to the degradation of Nafion used as an ion exchange membrane; furthermore H₂O₂ is generated due to electrode reactions, and radicals are generated due to its decomposition, thereby transforming the environment into a highly oxidative and highly corrosive state.

Ti-based metal separators exhibit significantly greater corrosion resistance than stainless steel-based metal separators in the presence of chloride ions (Cl⁻). This is attributed to the characteristics of the TiO₂ passive film formed on the surface of the Ti-based metal separator. However, the TiO₂ passive film is also rapidly dissolved when exposed to fluoride ions (F⁻) and acid. Thus, this leads to a rapid decline in corrosion resistance.

To address this issue, methods for improving corrosion resistance include: coating the surface to prevent the formation of an electrochemical circuit (cell) on the surface, utilizing sacrificial corrosion protection by forming a layer with a higher potential over the layer to be protected (e.g., a hot-dip galvanized layer or a matte-bright nickel plating layer), or geometrically distributing corrosion (e.g., introducing a pore layer in bright nickel plating or controlling surface roughness) to prevent it from concentrating in a single location. However, when corrosion resistance is improved using these methods, contact resistance increases, leading to a decrease in electrical conductivity.

Therefore, to address these issues, a metal separator having excellent electrical conductivity and corrosion resistance, and a method for manufacturing the same are required.

### SUMMARY

An object of the present disclosure is to provide a metal separator having excellent electrical conductivity and corrosion resistance, and a method for manufacturing the same.

According to an aspect of the present disclosure, a metal separator includes a substrate comprising titanium or a titanium alloy; a reaction layer formed on the substrate and including a plurality of protrusions; and a corrosion product layer formed on the reaction layer.

The protrusions may form an angle of 10° or more and 90° or less with respect to a vertical plane.

In addition, the reaction layer may have a thickness of 100 nm or more and 700 nm or less.

In addition, the corrosion product layer may include 3 at % or more and 28 at % or less carbon, 0 at % or more and 4 at % or less nitrogen, 1 at % or more and 40 at % or less oxygen, 33 at % or more and 95 at % or less titanium, 0 at % or more and 3.0 at % or less sulfur, and 0 at % or more and 1.70 at % or less fluorine.

In addition, the corrosion product layer may have a thickness of 10 nm or more and 100 nm or less.

Furthermore, the metal separator may have a current density of 10 μA/cm² or less.

Furthermore, the metal separator may have a contact resistance of 10 mΩ·cm² or less.

According to another aspect of the present disclosure, in a method for manufacturing a metal separator, a surface of a substrate including titanium or a titanium alloy is immersed in an etching solution to remove an oxide layer present on the surface of the substrate, and a reaction layer including a plurality of protrusions, and a corrosion product layer are sequentially formed on the substrate.

In addition, the protrusions may form an angle of 10° or more and 90° or less with respect to a vertical plane.

In addition, the etching solution may include an etchant, an inorganic acid, and an organic corrosion inhibitor.

Furthermore, the etching solution may include 0.05 wt % or more and 1 wt % or less of an etchant, more than 0 wt % and 1 wt % or less of an inorganic acid, and more than 0 wt % and 5 wt % or less of an organic corrosion inhibitor.

Furthermore, the organic corrosion inhibitor may include one or more selected from the group consisting of an organic acid-based corrosion inhibitor, a neutral ether-based corrosion inhibitor, and an amine-based corrosion inhibitor.

Furthermore, the etching step may be performed at a temperature of 60° C. or more and 95° C. or less for 8 minutes or more and 60 minutes or less.

Furthermore, the corrosion product layer may be formed by a reaction of anions in the etching solution with the substrate.

### BRIEF DESCRIPTION OF DRAWINGS

FIG. 1 is an exemplary diagram showing a metal separator according to an embodiment of the present disclosure.

FIG. 2 is an exemplary diagram showing a substrate prior to performing etching in an etching step according to an embodiment of the present disclosure.

FIG. 3 is an exemplary diagram showing the removal of an oxide layer and the formation of protrusions by an etchant in an etching step according to an embodiment of the present disclosure.

FIGS. 4 to 8 are Scanning Electron Microscope (×10000) images showing the surfaces of the metal separators manufactured in Examples 1 and 2, and Comparative Examples 1 to 3, respectively.

FIGS. 9 to 13 are Scanning Electron Microscope (×10000) images showing the cross-sections along a direction perpendicular to the surfaces of the metal separators manufactured in Examples 1 and 2, and Comparative Examples 1 to 3, respectively.

### DETAILED DESCRIPTION

In the description of numerical ranges described herein, the notation “X to Y” indicates X or more and Y or less, unless otherwise specified. Furthermore, “or more” may be replaced by “exceeding,” and “or less” may be replaced by “less than.”

In addition, in the numerical ranges described stepwise herein, the upper or lower limit value described in a numerical range may be replaced with the upper or lower limit value of other numerical ranges described stepwise, and may also be replaced with the values shown in the Examples.

Hereinafter, the metal separator of the present disclosure will be described with reference to the appended drawings. The appended drawings are illustrative only, and the metal separator of the present disclosure is not limited to the appended drawings.

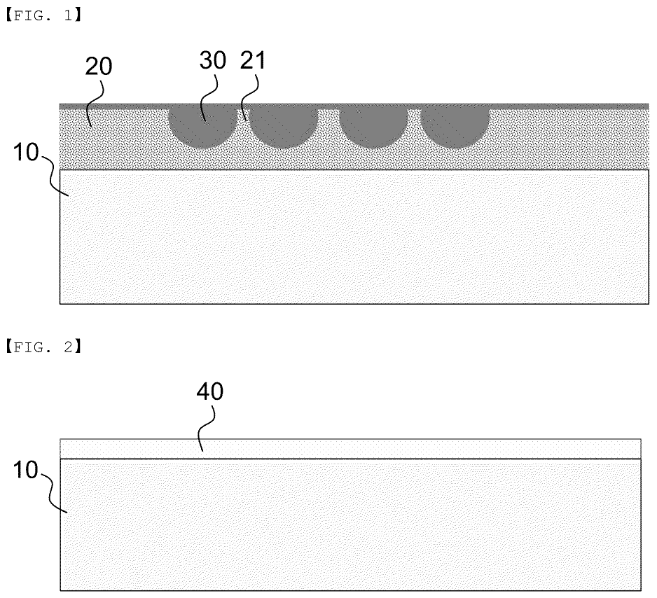

FIG. 1 is an exemplary diagram showing a metal separator according to an embodiment of the present disclosure. As shown in FIG. 1, the metal separator of the present disclosure sequentially includes a substrate 10, a reaction layer 20, and a corrosion product layer 30. The metal separator of the present disclosure may exhibit excellent electrical conductivity and corrosion resistance. The term “formed on” as used herein means formed on the surface. Furthermore, the term “surface” as used herein means the outermost surface. Furthermore, the term “formed on the surface” as used herein means formed on the outside of the surface.

The substrate 10 is a material used for a metal separator for a fuel cell.

For example, the substrate 10 includes titanium or a titanium alloy. Specifically, Grade 1, etc., may be used as the substrate 10. The substrate 10 includes the aforementioned components, thereby ensuring high potential and long-term corrosion resistance compared to stainless steel.

The substrate 10 may have a thickness of 0.05 mm or more and 0.5 mm or less. Here, the thickness of the substrate 10 refers to the length between any one surface and the opposite surface.

The reaction layer 20 is a layer formed on the substrate 10 by a reaction between the substrate 10 and an etching solution to be described below, and includes a plurality of protrusions 21. The reaction layer 20 includes a plurality of protrusions 21, thereby increasing the contact area and preventing a decrease in electrical conductivity. The term “a plurality of” as used herein means two or more, and unless specifically limited, the upper limit is not specifically limited. In addition, the term “protrusion” as used herein refers to a protruding portion formed between a plurality of grooves in the reaction layer, and, for example, has a height of 90 μm or more in the thickness direction from the maximum depth of adjacent grooves.

In one example, the protrusion 21 may form an angle of 10° or more and 90° or less with respect to a vertical plane. When the angle of the protrusions 21 with respect to the vertical plane satisfies the aforementioned range, grooves (Pits) may be formed between the plurality of protrusions. By forming grooves between the plurality of protrusions, the etching solution to be described below may reduce and precipitate titanium ions of the reaction layer 20, resulting in continuous coating growth and the formation of a corrosion product layer 30 in the grooves. Conversely, when the angle of the protrusion 21 with respect to the vertical plane is less than the lower limit of the aforementioned range, the reduction and precipitation of titanium ions in the reaction layer 20 may not be readily achieved. Furthermore, when the angle of the protrusion 21 with respect to the vertical plane exceeds the upper limit of the aforementioned range, it may not be easy for the etching solution to be described below to penetrate. The term “vertical plane” as used herein refers to a plane along the thickness direction of the metal separator.

The reaction layer 20 may have a thickness of 100 nm or more and 700 nm or less. Here, the thickness of the reaction layer 20 refers to the length between any one surface of the reaction layer 20 that contacts the surface of the substrate 10 and the opposite surface, and refers to the thickness including the protrusion 21.

In one example, the reaction layer 20 may include titanium and titanium carbide. Here, the titanium carbide may be formed by a reaction between titanium of the substrate 10 and carbon generated from the decomposition of organic matter in the organic corrosion inhibitor during the etching step to be described below.

The corrosion product layer 30 is a layer that improves the corrosion resistance of the metal separator, and is formed on the reaction layer 20.

In one example, the corrosion product layer 30 may include a titanium salt such as titanium hydrate, titanium hydroxide, and/or titanium fluoride, and may include, as elements, 3 at % or more and 28 at % or less carbon, 0 at % or more and 4 at % or less nitrogen, 1 at % or more and 40 at % or less oxygen, 33 at % or more and 95 at % or less titanium, 0 at % or more and 3.0 at % or less sulfur, and 0 at % or more and 1.70 at % or less fluorine. The corrosion product layer 30 includes elements having the aforementioned content, thereby ensuring corrosion resistance.

For example, the corrosion product layer 30 may have a thickness of 10 nm or more and 100 nm or less. When the thickness of the corrosion product layer 30 satisfies the aforementioned range, the layer is dense and may suppress oxygen diffusion and permeation, thereby not only improving the corrosion resistance of the metal separator but also enhancing its electrical conductivity. Conversely, when the thickness of the corrosion product layer 30 is less than the lower limit of the aforementioned range, the electrical conductivity of the metal separator may be improved, but the corrosion resistance of the metal separator may be reduced. Furthermore, when the thickness of the corrosion product layer 30 exceeds the upper limit of the aforementioned range, the corrosion resistance of the metal separator may be improved, but the contact resistance may excessively increase, making it impossible to ensure the target electrical conductivity of the metal separator.

The metal separator may have a current density of 10 μA/cm² or less. Specifically, the metal separator may have a current density of 5 μA/cm² or less or 3 μA/cm² or less. When the current density of the metal separator satisfies the aforementioned range, excellent corrosion resistance may be achieved. Furthermore, in that the lower the current density of the metal separator, the better the corrosion resistance, the lower limit is not particularly limited, but may be, for example, 0.1 μA/cm² or more.

Furthermore, the metal separator may have a contact resistance of 10 mΩ·cm² or less. Specifically, the metal separator may have a contact resistance of 9.5 mΩ·cm² or less or 9 mΩ·cm² or less. When the contact resistance of the metal separator satisfies the aforementioned range, excellent electrical conductivity may be achieved. Furthermore, in that the lower the contact resistance of the metal separator, the better the electrical conductivity, the lower limit is not particularly limited, but may be, for example, 1 mΩ·cm² or more, specifically, 3 mΩ·cm² or more or 5 mΩ·cm² or more.

The present disclosure also relates to a method for manufacturing a metal separator. The method for manufacturing the metal separator relates to a method for manufacturing the aforementioned metal separator. Since the specific details of the metal separator are the same as described above, overlapping descriptions will be omitted.

The method for manufacturing a metal separator of the present disclosure includes an etching step. According to the method for manufacturing a metal separator of the present disclosure, by including the etching step, the reaction layer and the corrosion product layer described above may be sequentially formed on the surface of the metal separator being manufactured, specifically on the surface of the substrate. As a result, the manufactured metal separator may exhibit excellent electrical conductivity and corrosion resistance.

The etching step is a step for improving the corrosion resistance of a substrate including titanium or a titanium alloy without reducing its electrical conductivity. This step is performed by immersing the surface of the substrate in an etching solution to remove the oxide layer present on the surface of the substrate, and forming, on the substrate, a reaction layer including a plurality of protrusions and the corrosion product layer. For example, the oxide layer may be a titanium oxide layer formed by natural oxidation of the substrate. Here, a detailed explanation of the formation angle of the protrusions is the same as described for the metal separator, and thus will be omitted.

In one example, the etching solution may include an etchant, an inorganic acid, and an organic corrosion inhibitor.

Specifically, the etching solution may include 0.05 wt % or more and 1 wt % or less of an etchant, more than 0 wt % and 1 wt % or less of an inorganic acid, and more than 0 wt % and 5 wt % or less of an organic corrosion inhibitor. When the etching solution includes each component within the aforementioned content range, a plurality of protrusions may be formed along the aforementioned angles on the reaction layer, and the corrosion product layer may be formed on the reaction layer. Thus, the manufactured metal separator may exhibit excellent electrical conductivity and corrosion resistance. Conversely, when the content of the etchant in the etching solution is less than the lower limit of the aforementioned range, it may be difficult to form a plurality of protrusions within the aforementioned angle range on the reaction layer. In addition, when the content of the etchant in the etching solution exceeds the upper limit of the aforementioned range, a full-surface etching may be layer, making it difficult to performed on the reaction ensure electrical conductivity.

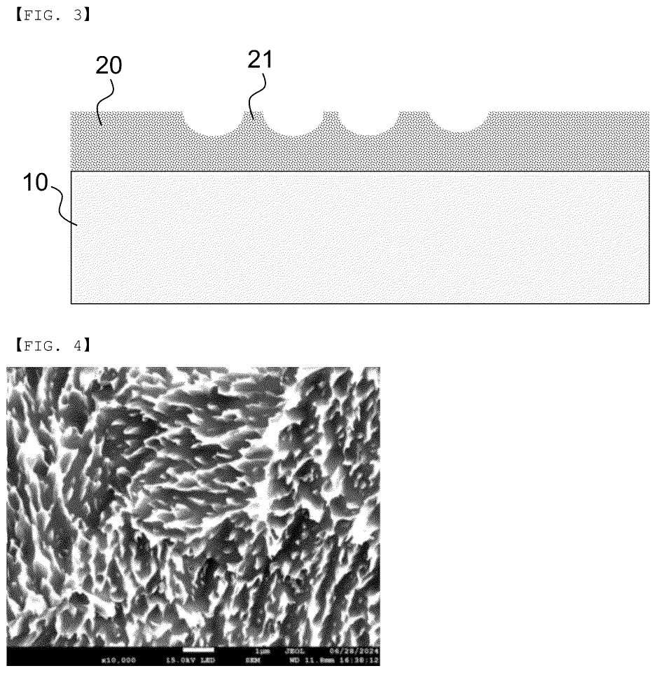

For example, as the etchant, one or more selected from the group consisting of hydrofluoric acid (HF), ammonium fluoride, and ammonium bifluoride (ABF) may be used. In the etching step, by using the aforementioned etchants, as shown in FIGS. 1 to 3, an oxide layer 40 may be removed through etching, and the reaction layer 20 including a plurality of protrusions 21 and the corrosion product layer 30 may be sequentially formed on the substrate 10, thereby improving electrical conductivity and corrosion resistance.

Furthermore, as the inorganic acid, one or more selected from the group consisting of nitric acid or sulfuric acid may be used. In the etching step, by using the aforementioned inorganic acid, the hydrogen (H⁺) generated by the reaction of the fluorine (F⁻) in the etchant with the oxide layer 40 may be continuously removed.

In addition, as the organic corrosion inhibitor, one or more selected from the group consisting of an organic acid-based corrosion inhibitor, a neutral ether-based corrosion inhibitor, and an amine-based corrosion inhibitor may be used. For example, as the organic acid-based corrosion inhibitor, ethylenediaminetetraacetic acid (EDTA), etc., may be used. Furthermore, as the neutral ether-based corrosion inhibitor, polyethylene glycol (PEG), etc., may be used. Furthermore, as the amine-based corrosion inhibitor, phenelzine and/or aminoguanidine (AMGN), etc., may be used. In the etching step, by using the aforementioned organic corrosion inhibitor, as shown in FIG. 1, the organic corrosion inhibitor may be adsorbed onto the surface of the reaction layer 20 between the plurality of protrusions 21 formed during etching to prevent excessive etching by the etchant.

In another example, the etching solution may further include distilled water as a base solvent, and may further include one or more solvents selected from ethanol and methanol as an additional solvent.

In one example, the etching step may be performed by immersing the surface of the substrate in the etching solution at 60° C. or more and 95° C. or less for 8 minutes or more and 60 minutes or less. Specifically, the etching step may be performed by immersing the surface of the substrate in the etching solution at a temperature of 60° C. or more and 80° C. or less for 9 minutes or more and 30 minutes or less, or 10 minutes or more and 20 minutes or less. By performing the etching step under the aforementioned temperature and time conditions, the oxide layer present on the surface of the substrate may be removed through etching, and the reaction layer including a plurality of protrusions, and the corrosion product layer may be sequentially formed on the substrate. Thus, the manufactured metal separator may exhibit excellent electrical conductivity and corrosion resistance.

As shown in FIG. 1, the corrosion product layer 30 may be formed by reacting anions in the etching solution with the substrate 10 during the etching step. By forming the corrosion product layer using the aforementioned method, the metal separator may ensure excellent corrosion resistance.

In one example, the method for manufacturing the metal separator may further include a degreasing step. The degreasing step is a pretreatment step performed before the etching step, and may be performed by removing, through degreasing, the adsorbed-gas layer present on the surface of the substrate during the process, as well as the contamination layer caused by rolling oil, press oil, and/or rust-preventive oil, which are contaminants. The method for manufacturing the metal separator may further include a degreasing step, thereby reducing resistance and improving electrical conductivity.

Hereinafter, the present disclosure will be described in more detail through Examples according to the present disclosure and Comparative Examples not according to the present disclosure, but the scope of the present disclosure is not limited by the Examples set forth below.

### Example 1

### Manufacturing of Metal Separator

A titanium substrate (Grade 1) with a thickness of 0.1 mm was prepared. Here, a TiO₂ oxide layer was present on the surface of the substrate.

Then, a metal separator was manufactured through etching in which the surface of the substrate was immersed in the etching solution shown in Table 1 below at 60° C. for 10 minutes.

### Example 2

### Manufacturing of Metal Separator

A metal separator was manufactured in the same manner as in Example 1, except that the etching time was 20 minutes.

### Comparative Example 1

### Manufacturing of Metal Separator

A metal separator was manufactured in the same manner as in Example 1, except that the etching time was 5 minutes.

### Comparative Example 2

### Manufacturing of Metal Separator

A metal separator was manufactured in the same manner as in Example 1, except that the etching time was 120 minutes.

### Comparative Example 3

### Manufacturing of Metal Separator

A metal separator was manufactured in the same manner as in Example 1, except that the etching solution shown in Table 1 below was used as the etching solution.

TABLE 1

| | Etching solution | | | | |
|---|---|---|---|---|---|
| | | | Organic | | Angle |
| | | | corrosion | | between |
| | Etchant | Inorganic | inhibitor | | protrusion |
| | (wt %) | acid (wt %) | (wt %) | Solvent | and |
| | Hydrofluoric | Nitric | Polyethylene | (wt %) | vertical |
| | acid | acid | glycol | Distilled | Plane |
| | (HF) | (HNO₃) | (PEG) | water | (°) |
| Example | 0.2 | 4 | 1 | 94.8 | 50 |
| 1 | | | | | |
| Example | 0.2 | 4 | 1 | 94.8 | 60 |
| 2 | | | | | |
| Comp. | 0.2 | 4 | 1 | 94.8 | 4 |
| Example | | | | | |
| 1 | | | | | |
| Comp. | 0.2 | 4 | 1 | 94.8 | 0 |
| Example | | | | | |
| 2 | | | | | |
| Comp. | 0.2 | 4 | 0 | 95.8 | 7 |
| Example | | | | | |
| 3 | | | | | |

### Evaluation Example 1. Protrusion Angle Evaluation

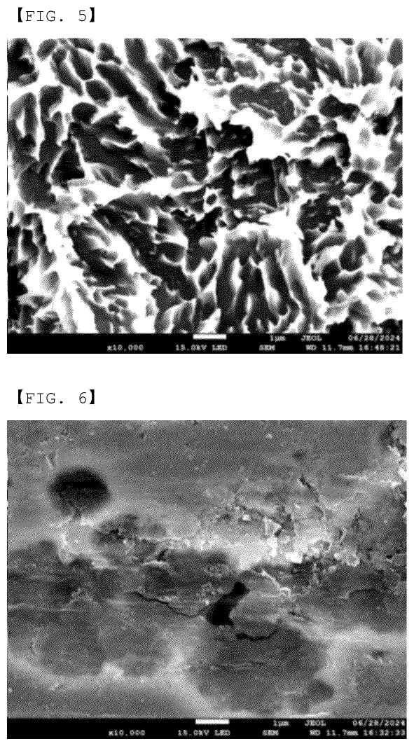

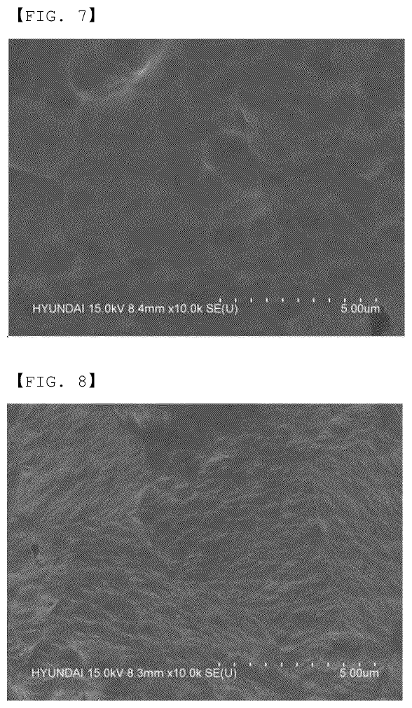

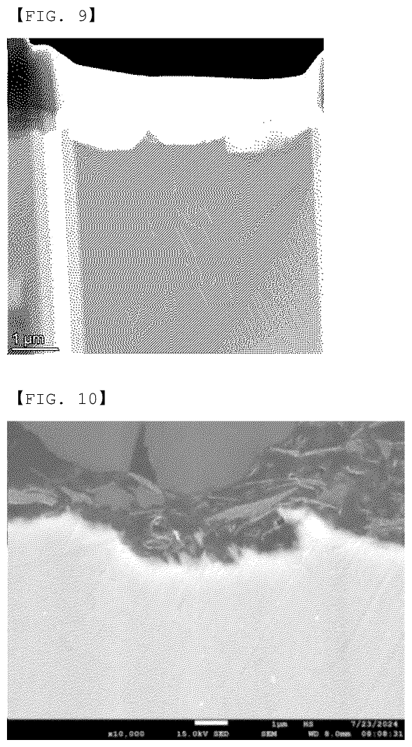

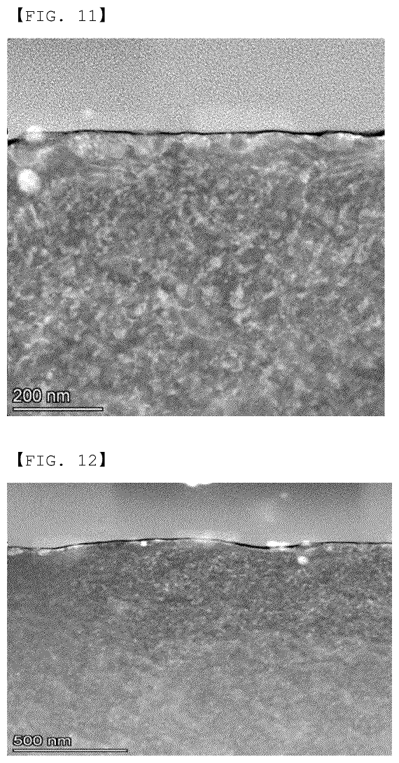

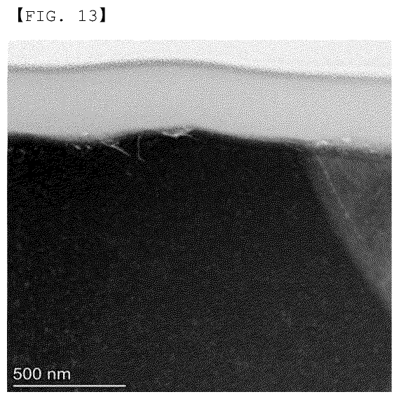

The surface and the cross-section along the direction perpendicular to the surface of the metal separators manufactured in each of the Examples and Comparative Examples were photographed using a Scanning Electron Microscope (SEM). Subsequently, the angle formed by the protrusions formed on the surface of the substrate with respect to the vertical plane was measured, and the results are shown in Table 1 and FIGS. 4 to 13.

### Evaluation Example 2. Current Density Evaluation

The current density for the metal separators manufactured in each of the Examples and Comparative Examples was measured by conducting a cyclic potentiodynamic test, in which the potential was cycled from −0.25 V vs open circuit potential (OCP) up to 1.0 V and then down to 0 V against an Ag/AgCl reference electrode under a simulated polymer electrolyte membrane fuel cell (PEMFC) environment, while the current-density pattern was recorded. The results are shown in Table 2. Here, the current density of the metal separators manufactured in each of the Examples and Comparative Examples was measured at 0.6 V.

### Evaluation Example 3. Contact Resistance Evaluation

After applying a contact pressure of 1.0 MPa to the metal separators manufactured in each of the Examples and Comparative Examples, the contact resistance was measured using an ammeter from HIOKI Corporation, and the results are shown in Table 2 below.

TABLE 2

| | Current density | Contact resistance |
|---|---|---|
| | (μA/cm²) | (mΩ · cm²) |
| Example 1 | 2.7 | 9 |
| Example 2 | 1.2 | 9 |
| Comp. Example 1 | 122.8 | 16.5 |
| Comp. Example 2 | 14.5 | 21 |
| Comp. Example 3 | 3.5 | 25 |

As shown in Table 1 and FIGS. 4 to 13, it was confirmed that the metal separators manufactured in each of Examples 1 and 2, unlike those manufactured in each of Comparative Examples 1 to 3, satisfied a specific angle range of the protrusions with respect to the vertical plane as a result of including an organic corrosion inhibitor in the etching solution within a predetermined content range and maintaining the etching time within a predetermined range. Accordingly, as shown in Table 2, it was confirmed that the metal separators manufactured in each of Examples 1 and 2, unlike those manufactured in each of Comparative Examples 1 to 3, exhibited both low current density and low contact resistance. Thus, it was confirmed that both excellent electrical conductivity and excellent corrosion resistance could be ensured.

According to the present disclosure, a metal separator having excellent electrical conductivity and corrosion resistance, and a method for manufacturing the same may be provided.

### DESCRIPTION OF SYMBOLS

10: Substrate
20: Reaction layer
21: Protrusion
30: Corrosion product layer
40: Oxide layer

What is claimed is:

1. A metal separator comprising:
a substrate including titanium or a titanium alloy;
a reaction layer formed on the substrate and including a plurality of protrusions; and
a corrosion product layer formed on the reaction layer.

2. The metal separator of claim 1, wherein the protrusions form an angle of 10° or more and 90° or less with respect to a vertical plane.

3. The metal separator of claim 1, wherein the reaction layer has a thickness of 100 nm or more and 700 nm or less.

4. The metal separator of claim 1, wherein the corrosion product layer includes 3 at % or more and 28 at % or less carbon, 0 at % or more and 4 at % or less nitrogen, 1 at % or more and 40 at % or less oxygen, 33 at % or more and 95 at % or less titanium, 0 at % or more and 3.0 at % or less sulfur, and 0 at % or more and 1.70 at % or less fluorine.

5. The metal separator of claim 1, wherein the corrosion product layer has a thickness of 10 nm or more and 100 nm or less.

6. The metal separator of claim 1, wherein the current density is 10 μA/cm² or less.

7. The metal separator of claim 1, wherein the contact resistance is 10 mΩ·cm² or less.

8. A method for manufacturing a metal separator, the method comprising an etching step in which a surface of a substrate including titanium or a titanium alloy is immersed in an etching solution to remove an oxide layer present on the surface of the substrate, and a reaction layer including a plurality of protrusions, and a corrosion product layer are sequentially formed on the substrate.

9. The method of claim 8, wherein the protrusions form an angle of 10° or more and 90° or less with respect to a vertical plane.

10. The method of claim 8, wherein the etching solution includes an etchant, an inorganic acid, and an organic corrosion inhibitor.

11. The method of claim 10, wherein the etching solution includes 0.05 wt % or more and 1 wt % or less of an etchant, more than 0 wt % and 1 wt % or less of an inorganic acid, and more than 0 wt % and 5 wt % or less of an organic corrosion inhibitor.

12. The method of claim 10, wherein the organic corrosion inhibitor includes one or more selected from the group consisting of an organic acid-based corrosion inhibitor, a neutral ether-based corrosion inhibitor, and an amine-based corrosion inhibitor.

13. The method of claim 8, wherein the etching step is performed at a temperature of 60° C. or more and 95° C. or less for 8 minutes or more and 60 minutes or less.

14. The method of claim 8, wherein the corrosion product layer is formed by a reaction of anions in the etching solution with the substrate.
